(19) United States
(12) Patent Application Publication
(10) Pub. No.: US 2026/0064879 A1
(43) Pub. Date: Mar. 5, 2026

(54) TRUST LAYER FOR GENERATIVE ARTIFICIAL INTELLIGENCE (AI) APPLICATION

(71) Applicant: Salesforce, Inc., San Francisco, CA (US)

(72) Inventors: Oleksandr MINAIEV, Munster, IN (US); Tejas SANGHAVI, San Francisco, CA (US); Subha MELAPALAYAM, Sammamish, WA (US); Prithvi Krishnan PADMANABHAN, San Ramon, CA (US); Atul Chandrakant KSHIRSAGAR, San Ramon, CA (US)

(21) Appl. No.: 18/823,513

(22) Filed: Sep. 3, 2024

(51) Int. Cl. G06F 21/62; G06F 21/57

(52) U.S. Cl. CPC G06F 21/6245; G06F 21/57

(57) ABSTRACT

A computer-implemented method is disclosed for predicting, based on a previous usage of a cloud-based computing resource by a number of users, a future usage of the cloud-based computing resource and then predicting, based on the predicted future usage, an anomaly event at the computing resource. The method also includes identifying a top contributing user that is responsible for the anomaly event and throttling an access of the top contributing user to the computing resource. The method further includes evaluating a speed of data requests received at the computing resource from the top contributing user after the throttling, and a utilization level of the computing resource. The method also includes dynamically adjusting the speed of data requests received at the computing resource, based on the evaluation of the utilization level of the computing resource, to maintain the utilization level of the computing resource within a predetermined target range.

### BACKGROUND

The present disclosure relates generally to the field of database systems and data processing, and more specifically to building and configuring trust layers for Generative Artificial Intelligence (AI) Applications that include large language models (LLMs).

Over the years, Businesses and their customers have grown increasingly concerned about protection of data privacy, regulatory compliance such as General Data Protection Regulation (GDPR), and ethical implications of AI-generated content. In this regard, one of the persistent concerns has been the users lacking transparency, control, and configurability over the detection and moderation mechanisms of sensitive data and harmful content within AI-generated outputs. Traditional AI platforms offer merely generic and limited customization for content moderation, often applying one-size-fits-all policies that do not account for the diverse needs and preferences of different users and contexts. This shortcoming may lead to mistrust, reduced adoption, and potential legal and reputational risks for businesses that utilize generative AI technologies.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating a simplified system model of a trust configuration framework in a Generative Artificial Intelligence (AI) application.

FIG. 1B is a block diagram illustrating an example user interface (UI) used in a Generative Artificial Intelligence (AI) application of FIG. 1A.

FIG. 2A is a simplified system model of a trust framework in a Generative Artificial Intelligence (AI) application of FIG. 1A.

FIG. 2B is a sequence diagram illustrating an example sequence of operations in a Generative Artificial Intelligence (AI) application of FIG. 1A.

FIG. 3 is a flow diagram illustrating an example method of deploying a trust framework in a Generative Artificial Intelligence (AI) application of FIG. 1A.

FIG. 4A is a block diagram illustrating an exemplary electronic device according to an example implementation.

FIG. 4B is a block diagram of an exemplary deployment environment according to an example implementation.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

The proposed solution provides a method and system for operationalizing a user-configurable foundational trust layer for a generative AI application. Embodiments of the present disclosure describe a method and system for deploying a user-configurable foundational trust layer for a generative AI application. A large language model (LLM) gateway may receive a prompt from a user, and a number of configuration parameters controlling data privacy, trust based content moderation, regulatory compliance, and business contexts specific to the user, in the prompt. The configuration parameters may be transparent to and configurable by the user. The large language model (LLM) gateway may determine presence of sensitive information in the prompt and in response to determining that sensitive information is present in the prompt, the LLM gateway may receive a moderated version of the prompt that may include a moderated version of the sensitive information.

Further, the LLM gateway may receive a response to the moderated version of the prompt and the LLM gateway may determine presence of unsafe information in the response. In response to determining that unsafe information is present in the response, the LLM gateway may generate, in real-time, a safe version of the response that may include a moderated version of the unsafe information, by controlling at least one of the configuration parameters.

In an aspect of the disclosed subject matter, a computer-implemented method for deploying a trust layer for a generative AI application is disclosed. The trust layer may be configurable by the user at a number of granularity levels comprising: an organization level, an application level, a prompt level, and a model level.

The method may include a large language model (LLM) gateway receiving a prompt from a user via a user interface coupled with the LLM gateway. The method may further include the LLM gateway receiving a number of configuration parameters controlling at least one of: data privacy, trust based content moderation, regulatory compliance, and a business context specific to the user, in the prompt. The configuration parameters may be transparent to the user. The LLM gateway may query an AI metadata service (AMS) via a number of application programming interfaces (API), and may receive from the AMS metadata associated with the LLM gateway. The metadata may include information about the configuration parameters.

The method may also include the LLM gateway determining a presence of sensitive information in the prompt and in response to determining that sensitive information is present in the prompt, the LLM gateway receiving a moderated version of the prompt. The moderated version of the prompt may include a moderated version of the sensitive information. The LLM gateway may send the prompt to a content moderation service (CMS) and the CMS may determine the presence of sensitive information in the prompt. The CMS may apply a predetermined content quality moderating action on the prompt, in real-time, based on the configuration parameters, and generate the moderated version of the sensitive information. The predetermined content quality moderating action may include blocking or masking or alerting about at least a part of the content, based on a content quality threshold score and a content quality moderation policy defined by the user.

The method may further include the LLM gateway receiving a response to the moderated version of the prompt and determining a presence of unsafe information in the response. The LLM gateway may send the prompt to an external generative AI model and the external generative AI model may generate the response. The unsafe information in the response may include a toxic content in the prompt. In response to determining that unsafe information is present in the response, the LLM gateway may generate a safe version of the response, in real-time, by controlling at least one of the configuration parameters. The safe version of the response may include a moderated version of the unsafe information. The safe version of the response may be sent to the user by the LLM gateway.

The sensitive information in the prompt may include at least one element of personally identifiable information (PII) in the prompt such as personal identity, phone number, email address, location, social security number, income tax identification number, driving license number, passport number, credit card number, and bank account number.

The method may further include extending the trust layer by analyzing an additional content moderation criterion based on at least one of: an anticipated policy, an anticipated standard and an anticipated threat related to trust and safety of the user, and applying a corresponding content moderation action.

In an aspect of the disclosed subject matter, a non-transitory machine-readable storage medium is disclosed that provides instructions that, if executed by a processor, are configurable to cause said processor to perform operations and methods for deploying a trust layer for a generative AI application, as disclosed herein.

In an aspect of the disclosed subject matter, a system is disclosed for deploying a trust layer for a generative AI application. The system may include a computer processor configured to run a public cloud network digitally connected with the computer processor. The system may also include a non-transitory machine-readable storage medium that provides instructions that are configurable to cause the apparatus to perform any of the methods disclosed herein.

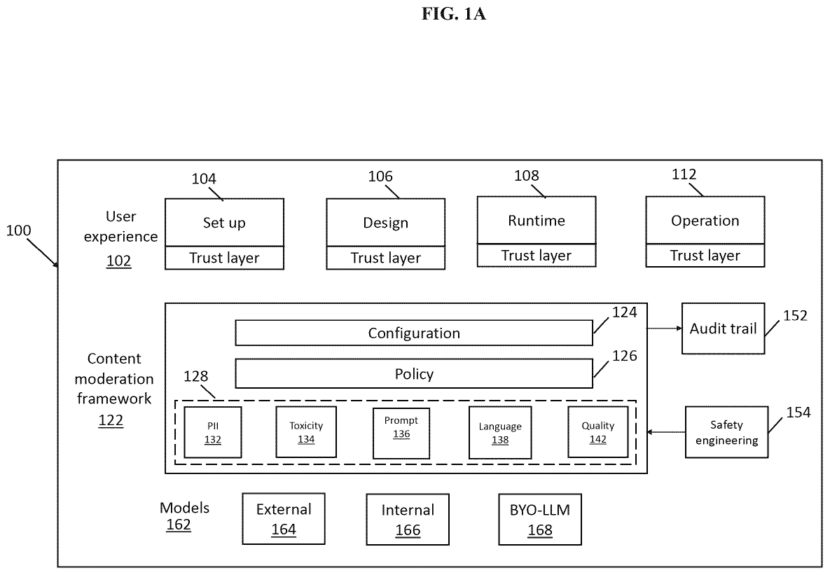

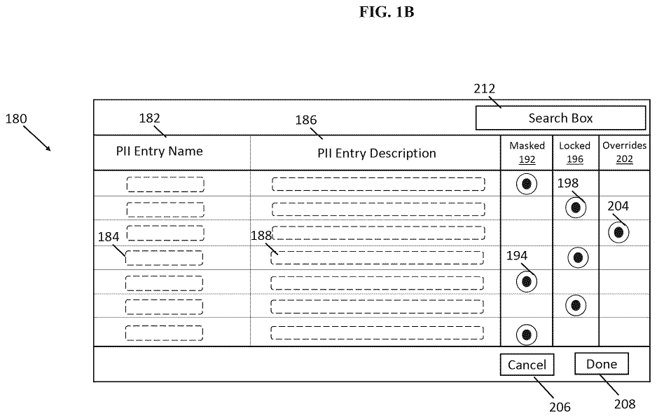

FIG. 1A is a block diagram illustrating a simplified system model 100 of a trust configuration framework in a Generative Artificial Intelligence (AI) application. The system model 100 may be designed as a user-friendly framework enabling technical and non-technical users alike to define and monitor and control trust configurations easily ensuring trust configurations policies are up-to-date and compliant with evolving standards. Referring to FIG. 1A, the system model 100 may include a user experience layer 102 having several functionality modules, such as a setup module 104 with its associated trust layer, a design module 106 with its associated trust layer, a runtime module 108 with its associated trust layer, an operation module 112 with its associated trust layer, and the like. The user experience layer 102 may be designed to ensure that the Generative Artificial Intelligence (AI) application operates transparently, reliably and in alignment with user expectations.

Referring to FIG. 1A, the set up module 104 may typically guide users through the initial setup of the generative AI system including configuration of preferences and trust settings and allow users to define metadata parameters that control AI behavior such as ethical guidelines data usage policies and privacy settings permission settings, ensure users can set permissions for data access and AI functionalities establishing boundaries for what the AI can and cannot do. The trust layer associated with set up module 102 may provide clear explanations of what data is being used and how that may impact AI behavior, ensure that users give informed consent for data usage and AI operations, and keep detailed logs of setup activities for accountability and review.

The design module 106 may allow users to design the AI interaction interfaces ensuring the system is intuitive and aligned with user needs, facilitate the integration of AI capabilities into existing user workflows and systems, provide tools for users to simulate and test AI behavior before deployment ensuring it needs desired outcomes. The trust layer associated with the design module 106 may offer clear visualization of how design choices impact AI behavior and outcomes, incorporate feedback loops where users can report issues or suggest improvements enhancing trust in the system's adaptability, and ensure design choices comply with ethical standards regulations and best practices.

The runtime module 108 may monitor and control the real time operation of the API handling user queries generating responses and performing tasks, continuously monitor the performance and accuracy of AI outputs during operation, and allow the AI to learn and adapt for real time interactions while adhering to predefined trust parameters. The trust layer associated with the runtime module 108 may provide users with real time insights into AI decision making processes and data usage, ensure any errors or unexpected behaviors are immediately reported and addressed, regularly validate AI outputs against trust criteria to ensure ongoing reliability and accuracy.

Continuing to refer to FIG. 1A, the operation module 112 may monitor and control regular maintenance updates and upgrades of the AI system to ensure optimal performance, supervise data storage access and usage policies ensuring data integrity and security, provide ongoing user support and troubleshooting services. The trust layer associated with the operation module 112 may keep users informed about maintenance schedules updates and any changes to AI functionalities, ensure robust measures are in place to protect user data from breaches and misuse, establish clear accountability frameworks for AI operations including roles and responsibilities for monitoring and enforcement,

By integrating the setup module 104, the design module 106, the runtime module 108, and the operation module 112 with their associated trust layers, the user experience layer 102 may ensure that Generative Artificial Intelligence (AI) application is not only functional and efficient but also transparent, reliable and aligned with user expectations and ethical standards.

The system model 100 may include a content moderation framework 122 designed to maintain ethical standards for user safety and compliance with regulations. The content moderation framework 122 may include a configuration module 124 and a policy module 126.

The configuration module 124 may allow system administrators to define rules and parameters for content moderation based on organizational policies and regulatory requirements customizable settings, enable customization of moderation settings to fit different contexts user groups and content types, and ensure that the moderation settings are aligned with the trust layers defined in other modules maintaining consistency across the system.

The policy module 126 may facilitate creation, updating and management of content moderation policies, ensure that content moderation practices comply with legal ethical and organizational policies, and apply policies automatically to content generated or interacted with by the AI streamlining enforcement and reducing manual oversight.

The content moderation framework 122 may also include a personally identifiable information (PII) module 132, a toxicity module 130, a prompt module 136, a language module 138, and a quality module 142 to ensure that the generative AI application produces high quality, safe and compliant content so that the framework not only protects users but also maintains the integrity and trustworthiness of the AI system.

The PII module 132 may identify personally identifiable information within any generated content and either redact or anonymize that to protect user privacy, continuously monitor content for compliance with data privacy regulations like GDPR CPA etc., and provide users with options to control what personally identifiable information is shared and how it is handled by the AI system.

The toxicity moderation module 134 may utilize algorithms to detect harmful or toxic language and generated content including hate speech bullying and harassment, automatically filter over flags toxic content for review before it reaches the user, allow users to report toxic content and provides mechanisms for feedback to improve detection algorithms.

The prompt moderation module 136 may monitor user input prompts to ensure they adhere to acceptable use policies and do not solicit inappropriate content, block or modify prompts that are likely to generate harmful or inappropriate content, and provide feedback to users on why certain prompts are not allowed and suggests alternative phrasing.

The language moderation module 138 may identify the language of the content and ensure that the language meets predefined standards and policies, detect and filter out offensive or inappropriate language cultural sensitivity, and ensure that the content is culturally appropriate and sensitive to the context in which it is being used.

The content quality control module 142 may evaluate the quality of generated content against predefined criteria such as relevance coherence and accuracy, identify incorrect errors in the content such as grammatical mistakes factual inaccuracies and logical inconsistencies, collect and integrate user feedback to continuously improve the quality of content generation.

Continuing to refer to FIG. 1A, the system model 100 may further include an audit trail module 152 and a safety engineering module 154 to ensure transparency, accountability, and a safe operation of the AI system. By incorporating these modules, the generative AI application may ensure robust safety and accountability measures fostering user trust and compliance with regulatory standards. Specifically, the audit trail module 152 may ensure transparency and traceability of all activities while the safety engineering module 154 may proactively monitor and control and mitigate risks to maintain a secure and reliable AI system.

The user interface 100 may further include several Generative AI models 162 such as an example external module 164, an example internal module 166, an example bring-your-own (BYO) LLM module 168, and the like. Different deployment models of generative AI or large language models provide varying degrees of control customization and integration capabilities.

The example external generative AI model 164 may provide access to AI capabilities through APIs offered by third party providers, offload data processing and model inference to external servers monitored and controlled by the AI service provider, enable rapid deployment of AI capabilities without the need for extensive infrastructure setup.

The internal or hosted generative AI model 166 may deploy the AI model within the customer's own infrastructure providing full control over the environment, enhance data security by keeping all data and processing within the organization's network, allow for extensive customization of the AI model to meet specific organizational needs and requirements, optimize the deployment for the specific hardware and network infrastructure of the organization.

The Bring-your-own (BYO) generative AI model 168 may allow customers to bring their own AI models and deploy them in a variety of environments including cloud on premises or hybrid setups, ensure compatibility with existing systems and infrastructure providing flexibility and deployment choices, enable extensive customization of the AI models architecture training data and parameters to meet specific needs.

In an instance, the trust framework of system model 100 may be extended by including additional content analysis and moderation modules based on either an anticipated policy, or an anticipated standard or an anticipated threat related to trust and safety of the user, and applying a corresponding content moderation action.

FIG. 1B is a block diagram illustrating example user interface (UI) 180 used in a Generative Artificial Intelligence (AI) application of FIG. 1A. Referring to FIG. 1B, the example user interface 182 that may include a “PII Entry Name column” 182 and a “PII Entry Description” column 186. The PII Entry Name column 182 may include example entry names 184 and the PII Entry Name column may include example entry descriptions 188.

The user interface (UI) 180 may be configurable, as a flexible action layer, based on customer-defined trust thresholds and trust policies, enabling actions such as masking, blocking, alerting and so on. For example, the user interface 182 may include an example masked option column 192, an example locked option column 196, and an example override option column 202. The masked option column 192 may include an example configuration button 194, the locked option column 196 may include an example configuration button 198, and the overwrites option column 202 may include an example configuration button 204. In addition, the example user interface 182 may include a cancel button 206 and a done button 208. Further, example user interface 182 may include a search box 212.

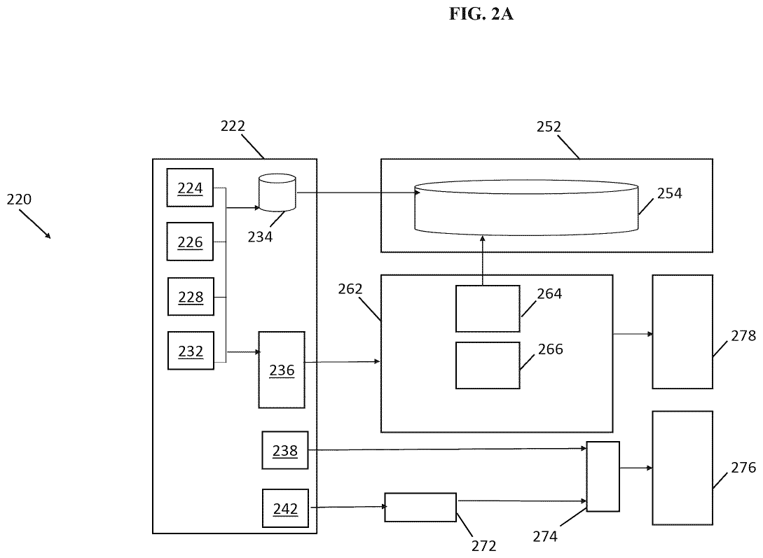

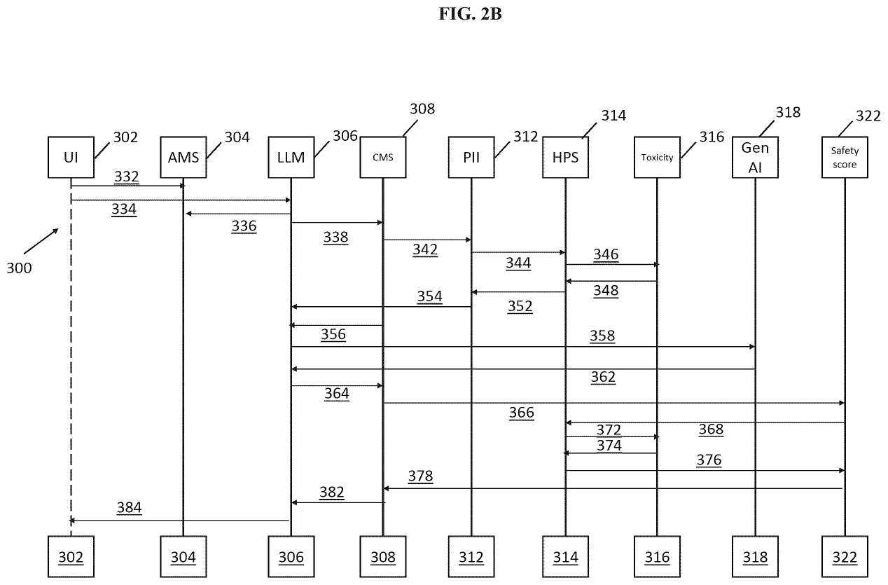

FIG. 2A is a simplified system model 200 of a Generative Artificial Intelligence (AI) application of FIG. 1A. Operationalizing trust configuration settings for generative AI or large language models involves ensuring that trust safety and compliance measures are implemented at various levels of the system. Referring to FIG. 2A, the system model 220 may include a user interface 222 having an organization level trust configuration set-up module 224, an application level trust configuration set-up module 226, a prompt level trust configuration set-up module 228, and a model level trust configuration set-up module 232. By operationalizing trust configuration settings at various levels organizations can ensure that their generative AI systems operate in a manner that is ethical, transparent and align with user expectations and regulatory requirements. This multi-level approach may help maintain trust and enhance user satisfaction and mitigates risk associated with AI deployment.

The organization level trust configuration set-up module 224 may establish global policies for AI use encompassing ethics data privacy and security, ensure adherence to industry regulations and organizational standards across all AI deployments. The individual application level trust configuration set-up module 226 may allow each application to define specific trust settings tailored to its unique use cases and user needs, adapt trust configurations based on the applications context such as different industries or user groups, continuously monitor the AI's performance and adherence to trust settings within the application. The user context or prompt level trust configuration set-up module 228 may allow users to set their own trust and safety preferences tailoring the AI's behavior to their needs, adapt trust settings in real time based on the context of user interactions and prompts, ensure users are aware of how their data will be used and what trust measures are in place. The model level trust configuration set-up module 232 may embed ethical guidelines directly into the LM training and operational parameters, apply techniques to minimize biases and ensure fairness in the model's outputs, regularly update and retrain the LLM with new data to improve accuracy relevance and inherence to trust settings.

Referring again to FIG. 2A, the user interface 222 may include a configuration database 234, a LLM gateway client 236 (described in more detail below), a Content Moderation Service (CMS) client 238 (described in more detail below), and a response evaluation client 242 (described in more detail below).

The system module 220 may include an AI metadata service (AMS) module 252 that may include a metadata configuration database 254. The AI metadata service refers to a system or platform that monitors and controls and provides access to metadata related to AI models and their outputs, stores and monitors and controls configuration settings, serving as a bridge between user inputs and configuration monitoring actions. The metadata may include various information types essential for ensuring trustworthiness, transparency and governance of AI applications.

The system module 220 may include a large language model (LLM) gateway 262 that may include an AMS client module 264 and a Content Moderation Service (CMS) module 266. As is commonly known in AI and ML art, large language model (LLM) may be a type of artificial intelligence (AI) program that uses machine learning to predict and generate human language content. LLMs are typically trained on large amounts of data, such as internet-scale datasets with hundreds of billions of parameters. This training allows LLMs to learn the patterns and structures of language, and to understand context by tracking relationships in sequential data. The Large Language Model (LLM) gateway LLM Gateway 262 may interface with external AI models, apply AMS configurations to moderate content in real-time and may be a centralized platform that acts as an intermediary between user applications and LLM services, allow for the integration of different AI models. The LLM gateway 262 may provide many benefits, including simplifying the process of integrating multiple LLM providers, eliminating the need to establish individual connections, providing access to a wide range of LLMs, post-processing tasks to improve the effectiveness of LLM interactions, helping organizations maintain control over costs and compliance by centralizing access, enabling logging and monitoring tools, and tracking data sent externally. The LLM Gateway 262 may be implemented on the same computer or cloud system as the LLM itself or may interface with multiple LLMs.

The CMS module 266 may be a central service for content analysis, flagging, and action recommendations and a crucial component designed to ensure that the output generated by AI systems adheres to acceptable standards and guidelines this service helps maintain the quality safety and appropriateness of the content produced thus building trust with users and stakeholders a content moderation service is a system or set of processes that reviews filters and monitors and controls that content generated by AI applications to ensure it complies with predefined standards and policies.

The system module 220 may further include a response evaluation module 272, a prediction module 274, a toxicity moderation module 276 for ensuring that the AI system operates transparently reliably and ethically.

The response evaluation module 272 may evaluate the correctness of AI generated responses against predefined benchmarks, assess how well the response addresses the user's query or task, ensure that responses are contextually appropriate and coherent within the ongoing interaction, validate that the response aligns with the users apparent intent and expectations.

The response prediction module 276 may predict the most likely next user query or response based on interaction history, anticipate potential user reactions or follow up actions to tailor responses, accordingly, simulate various interaction scenarios to predict possible outcomes and prepare appropriate responses, evaluate potential risks or negative outcomes of predicted responses to mitigate issues proactively.

The toxicity moderation module 276 may use algorithms to detect toxic, harmful or offensive content in generated responses, automatically filter or flag toxic content for review before it is delivered to users, continuously monitor generated responses for signs of toxicity, adjust moderation thresholds and parameters in real time based on user feedback and interaction context, provide users with an easy way to report toxic content they encounter.

The system module 220 may further include a Generative AI response module 278. The Generative AI response module 278 may utilize advanced NLP techniques to generate coherent contextually relevant responses, ensure responses are diverse and creative, avoiding repetitive or formulaic outputs, tailor responses based on individual user preferences and interaction history, maintain context awareness to provide responses that are relevant to the ongoing interaction, ensure generated responses adhere to safety guidelines and do not include harmful or inappropriate content, ensure responses comply with legal and regulatory requirements including data privacy and ethical standards.

In operation, a user may enter a prompt via the user interface 222 that is coupled with the LLM gateway 262. The LLM gateway 262 may query the AI metadata service (AMS) 252 via an AMS client 264 and number of application programming interfaces (API), and may receive from the AMS 252 metadata associated with the LLM gateway 262. The LLM gateway 262 may determine a presence of sensitive information in the prompt. In response to determining that sensitive information is present in the prompt, the LLM gateway 262 may send the prompt to the Content Moderation Service (CMS) 266 and the CMS 266 may determine the presence of sensitive information in the prompt. The CMS 266 may apply a predetermined content quality moderating action on the prompt, in real-time, based on the configuration parameters, and generate a moderated version of the sensitive information. The predetermined content quality moderating action may include blocking or masking or alerting about at least a part of the content, based on a content quality threshold score and a content quality moderation policy defined by the user. The LLM gateway 262 may receive a moderated version of the prompt and the moderated version of the prompt may include a moderated version of the sensitive information.

Further, the LLM gateway 262 may receive a response to the moderated version of the prompt and determine a presence of unsafe information in the response. The unsafe information in the response may include a content of toxic category, such as toxicity, hate, identity, violence, physical, sexual, profanity, and the like. In response to determining that unsafe information is present in the response, the LLM gateway 262 may generate a safe version of the response, in real-time, by controlling at least one of the configuration parameters. The safe version of the response may include a moderated version of the unsafe information. The LLM gateway 262 may send the prompt to an external generative AI model 278 and the external generative AI model 278 may generate the response. The safe version of the response may be sent to the user by the LLM gateway 262.

Referring again to FIG. 2A, the organization level trust configuration set-up module 224, the application level trust configuration set-up module 226, the prompt level trust configuration set-up module 228, and the model level trust configuration set-up module 232 may communicate with the LLM gateway client 236, which in turn, may communicate with the LLM gateway 262. The CMS client 238 may communicate with the prediction module 274. The response evaluation client 242 may communicate with the response evaluation module 272, which in turn, may communicate with the prediction module 274. The prediction module 274 may communicate with the toxicity moderation module 276 to operationalize the trust framework of this disclosure and ensure that the AI system operates transparently, reliably, safely and ethically.

In effect, the LLM gateway client 236 may act as an intermediary between the trust configuration modules (organization level trust configuration set-up module 224, the application level trust configuration set-up module 226, the prompt level trust configuration set-up module 228, and the model level trust configuration set-up module 232) and the LLM gateway 262 ensuring the trust settings are properly communicated and enforced and facilitates real time adjustments to trust settings based on feedback from various modules.

The CMS client 238 may monitor and control the flow of content and data ensuring that content generated by the AI adheres to trust configurations and continuously monitors generated content to ensure compliance with trust and safety policies.

The response evaluation client 242 may evaluate the quality relevance and safety of AI generated responses, collect and integrate user feedback to continuously refine and improve response quality, and ensure that responses adhere to trust configurations by communicating with the prediction module. The trust configuration setup modules may define and monitor and control trust settings at various levels such as organizational, individual application, prompt and model levels and communicate these settings to the LLM gateway client 236. The LLM gateway client 236 may act as a bridge and ensure that the LLM gateway 262 operates within the defined trust parameters making real time adjustments as necessary.

The prediction module 274 may utilize trust settings to predict appropriate and safe responses communicating with the CMS client 236 and the response evaluation client 238. The response evaluation module 272 may evaluate the generated responses for quality and adherence to trust settings providing feedback to the prediction module 274. The toxicity moderation module 276 may continuously monitor and filter generated content to ensure that it is free from harmful or inappropriate material. The CMS client 236 may monitor and control content flow and ensure compliance with trust and safety policies.

By integrating the modules described in FIG. 2A and ensuring seamless communication between them the trust framework of the current disclosure operationalizes the principles of transparency reliability safety and ethics and generative AI applications this comprehensive approach allows for dynamic adjustments and continuous monitoring ensuring that the AI system meets the highest standards of trust and user satisfaction.

FIG. 2B illustrates an example sequence diagram 300 for deploying a trust layer for a Generative Artificial Intelligence (AI) application of FIG. 1A. Referring to FIG. 2B and traversing from top to bottom and left to right, following the arrowing lines, an example user interface (UI) 302 may send a synchronization alert to an AMS 304 for synchronizing all relevant metadata, as in sequence 332. Further, the UI 302 may send a second request prompt to an LLM gateway 306 for a desired response, as in sequence 334. In response, the LLM gateway 306 may send a query requesting metadata from the AMS 304, as in sequence 336. Further, the LLM gateway 306 may send a preprocessing request to the CMS 308 to preprocess and moderate the content of the user prompt, as in sequence 338. In response, the CMS 308 may send a query requesting PII services to a PII module 312, as in sequence 342. In response, the PII module 312 may send a request to a Human Preference Synthesis (HPS) 314, for inputs on human preferences related to the content in the user prompt, as in sequence 344.

As is commonly known in artificial intelligence and machine learning art, a Human Preference Synthesis (HPS) is a functional module in a trust layer in LLM based generative AI designed to ensure that AI systems produce results that are trustworthy, safe and aligned with human values and expectations. HPS may typically focus on integrating human preferences directly into the AI's decision making and generative processes ensuring that the outputs are not only technically correct but also contextually and ethically aligned with human values and expectations.

Continuing to refer to FIG. 2B, the HPS 314 may send a request to a toxicity model 316 for checking content toxicity in the user prompt, as in the sequence 346. The toxicity model 316, may respond to the HPS 314, as in the sequence 348, that the text needs to be masked (or blocked or overridden), as in the sequence 352. Following on, the PII 312 may send the masked (or blocked or overridden) request to the LLM Gateway, as in the sequence 354. At the same time, the CMS 308 may send a demasked version of the post-processed prompt based on relevant configuration settings, as in the sequence 356. Following on, the LLM Gateway 306 may send a request to an external (or internal or bring-your-own or BYO) Generative AI model 318, as in the sequence 358. The Generative AI model 318 may send a response back to the LLM gateway, as in the sequence 362.

The LLM gateway 306 may send a processing request to the CMS 308 for safety score, as in the sequence 364. In response, the CMS 308 may send a safety score service request to a safety score module 322, as in the sequence 366. The safety score module 322 may send a request to the HPS module 314 for a safety model, as in the sequence 368. In response, the HPS module 314 may request the toxicity module 316 to generate a safety score, as in the sequence 372 and receive a response from the toxicity module 316, as in the sequence 374. The HPS 314 may send a request to the safety score module 322 for a safety score, as in the sequence 376 and in response, the safety score module 322 may return the safety score to the CMS 308, as in the sequence 378. Following on, the CMS 308 may send the safety score to the LLM Gateway 306 after moderating as per the configurations, as in the sequence 382. The LLM Gateway 306 may send the safe score to the user interface 302, as in the sequence 384, as a final response to the original prompt 334.

In an example use case, an organization may intend to ensure that user-generated prompts do not contain sensitive PII or toxic content and the organization may configure the trust configuration system to automatically mask detected PII types and block prompts with a high toxicity score. When an example user submits, for instance, a prompt containing an email address and mildly toxic content, the trust configuration system may mask the email and evaluate the content's toxicity level against the organization's threshold. If the content is below the configured threshold level for blocking, it may proceed with masked PII and a warning may be issues to the user about the detected toxicity.

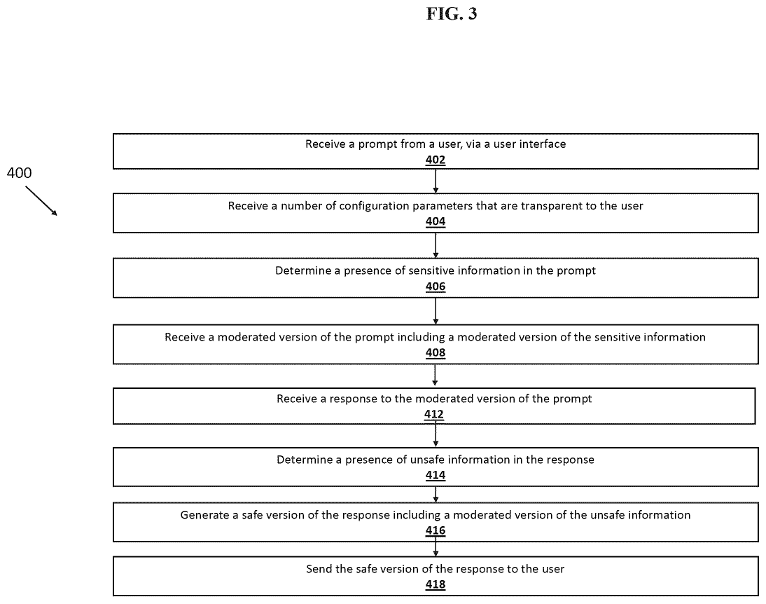

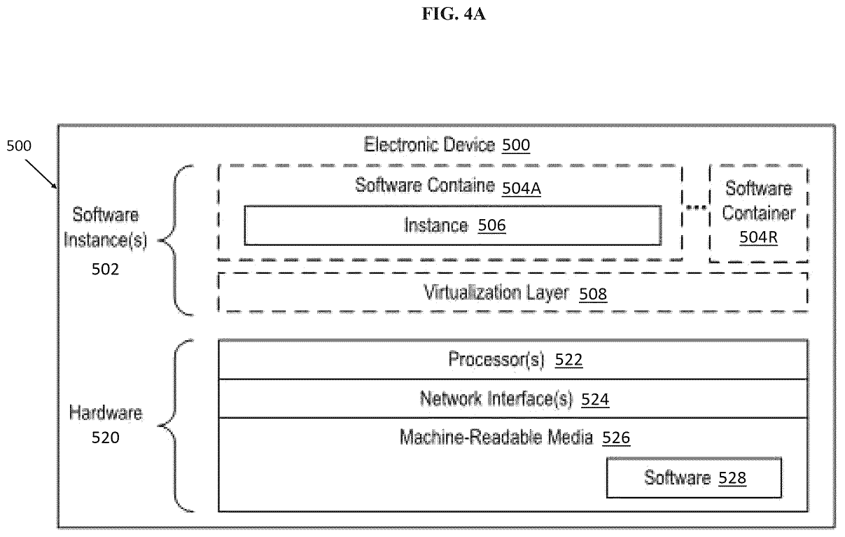

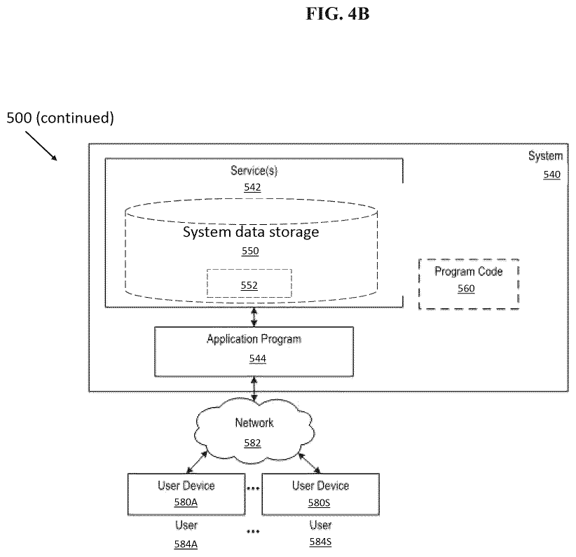

FIG. 3 is a flow diagram illustrating an example method 400 of deploying a trust framework in a Generative Artificial Intelligence (AI) application of FIG. 1A, as disclosed herein. The method 400 may be performed, for example, by a system as shown in FIGS. 1A to 2B operating in conjunction with the hardware as shown in FIGS. 4A and 4B and/or by software executing on a server or distributed computing platform. Although the steps of method 400 are presented in a particular order, this is only for simplicity.

The computer-implemented method 400 may include, as in step 402, a large language model (LLM) gateway may receive a prompt from a user, via a user interface coupled with the LLM gateway. At 404, the LLM gateway may receive a number of configuration parameters controlling at least one of data privacy, trust based content moderation, regulatory compliance, and a business context specific to the user, in the prompt. The configuration parameters may be transparent to the user.

At 406, the LLM gateway may determine a presence of sensitive information in the prompt. At 408, in response to determining that sensitive information is present in the prompt, the LLM gateway may receive a moderated version of the prompt. The moderated version of the prompt may include a moderated version of the sensitive information.

At 412, the LLM gateway receive a response to the moderated version of the prompt and at 414, the LLM gateway may determine a presence of unsafe information in the response. At 416, in response to determining that unsafe information is present in the response, the LLM gateway may generate a safe version of the response comprising a moderated version of the unsafe information, in real-time, by controlling at least one of the configuration parameters. At 418, the LLM gateway may send the safe version of the response to the user.

Embodiments of the present disclosure describe a method and system for deploying a user-configurable foundational trust layer for a generative AI application. A large language model (LLM) gateway may receive a prompt from a user, and a number of configuration parameters controlling data privacy, trust based content moderation, regulatory compliance, and business contexts specific to the user, in the prompt. The configuration parameters may be transparent to and configurable by the user. The large language model (LLM) gateway may determine presence of sensitive information in the prompt and in response to determining that sensitive information is present in the prompt, the LLM gateway may receive a moderated version of the prompt that may include a moderated version of the sensitive information.

Further, the LLM gateway may receive a response to the moderated version of the prompt and the LLM gateway may determine presence of unsafe information in the response. In response to determining that unsafe information is present in the response, the LLM gateway may generate, in real-time, a safe version of the response that may include a moderated version of the unsafe information, by controlling at least one of the configuration parameters. The LLM Gateway may be implemented on the same computer or cloud system as the LLM itself or may interface with multiple LLMs.

Thus, the system and method of the current disclosure may empower organizations to maintain control over content generated and processed by AI, adapting to diverse regulatory environments and use cases while prioritizing user trust and safety. Unlike most platforms that offer a one-size-fits-all solution for content moderation and PII detection, the current system and method may allow customers to configure detection thresholds and actions based on their specific needs. This flexibility may support diverse applications and organizational requirements, provide a tailored approach to trust and safety. The system's ability to configure settings at various levels (organization, application, prompt, and model) is unique and this granularity of control may allow for precise management of content moderation policies, ensuring they are relevant and effective across different contexts within the same organization.

With the capability to detect distinct entity types of PII, the system may offer a broader range of detection compared to standard solutions that may only focus on a limited set of PII categories. This comprehensive approach may enhance data protection and privacy compliance.

Further, the system and method of the current disclosure may evaluate content not just for PII but also for toxicity across seven categories, integrating content quality and safety measures. This dual focus is important for platforms seeking to maintain high standards of user interaction and content. The system may be designed to integrate additional detection methods over time and thereby ensure that it can adapt to evolving standards and threats, providing a future-proof solution for trust and safety in AI applications.

The system may be built on a scalable cloud infrastructure to handle varying loads. For example, RESTful APIs may be used for communication between components, ensuring modularity and case of integration and implement robust authentication and authorization mechanisms to secure access to configuration interfaces and APIs. Additionally, distributed databases with sharding (a database partitioning technique that splits data into horizontal partitions, or shards, across multiple databases or machines) may be utilized to monitor and control configuration data and ensure quick access and high availability. Further, microservices architecture may be employed for core components, allowing independent scaling of applications based on demand (e.g., the CMS module 266 of FIG. 2A may require more resources than the AMS 252 of FIG. 2A). Furthermore, caching mechanisms may be implemented for frequently accessed configuration data to reduce latency and database load. In addition, load balancing algorithms may be used to distribute requests evenly across services, preventing bottlenecks and ensuring responsive performance.

One or more parts of the above implementations may include software. Software is a general term whose meaning can range from part of the code and/or metadata of a single computer program to the entirety of multiple programs. A computer program (also referred to as a program) includes code and optionally data. Code (sometimes referred to as computer program code or program code) includes software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (typically, though not necessarily an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices. The term “consumer” refers to another computer service that is running the reusable software components of the system of FIG. 1.

FIG. 4A is a block diagram illustrating an electronic device 500 according to some example implementations. FIG. 4A includes hardware 520 including a set of one or more processor(s) 522, a set of one or more network interfaces 524 (wireless and/or wired), and machine-readable media 526 having stored therein software 528 (which includes instructions executable by the set of one or more processor(s) 522). The machine-readable media 526 may include non-transitory and/or transitory machine-readable media. Each of the previously described clients and server components may be implemented in one or more electronic devices 500. In one implementation: 1) each of the clients is implemented in a separate one of the electronic devices 500 (e.g., in end user devices where the software 528 represents the software to implement clients to interface directly and/or indirectly with server components (e.g., software 528 represents a web browser, a native client, a portal, a command-line interface, and/or an application programming interface (API) based upon protocols such as Simple Object Access Protocol (SOAP), Representational State Transfer (REST), etc.)); 2) server components is implemented in a separate set of one or more of the electronic devices 500 (e.g., a set of one or more server devices where the software 528 represents the software to implement the framework for providing additional security to protected fields in protected views); and 3) in operation, the electronic devices implementing the clients and server components would be communicatively coupled (e.g., by a network) and would establish between them (or through one or more other layers and/or other services) connections for submitting requests to server components and returning responses to the clients. Other configurations of electronic devices may be used in other implementations (e.g., an implementation in which the client and server components are implemented on a single one of electronic device 500).

During operation, an instance of the software 528 (illustrated as instance 506 and referred to as a software instance; and in the more specific case of an application, as an application instance) is executed. In electronic devices that use compute virtualization, the set of one or more processor(s) 522 typically execute software to instantiate a virtualization layer 508 and one or more software container(s) 504A-504R (e.g., with operating system-level virtualization, the virtualization layer 508 may represent a container engine (such as Docker Engine by Docker, Inc. or rkt in Container Linux by Red Hat, Inc.) running on top of (or integrated into) an operating system, and it allows for the creation of multiple software containers 504A-504R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-504R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 528 is executed within the software container 504A on the virtualization layer 508. In electronic devices where compute virtualization is not used, the instance 506 on top of a host operating system is executed on the “bare metal” electronic device 500. The instantiation of the instance 506, as well as the virtualization layer 508 and software containers 504A-504R if implemented, are collectively referred to as software instance(s) 502.

Alternative implementations of an electronic device may have numerous variations from that described above. For example, customized hardware and/or accelerators might also be used in an electronic device.

FIG. 4B is a block diagram of a deployment environment according to some example implementations. A system 540 includes hardware (e.g., a set of one or more server devices) and software to provide service(s) 542, including server components. In some implementations the system 540 is in one or more datacenter(s). These datacenter(s) may be: 1) first party datacenter(s), which are datacenter(s) owned and/or operated by the same entity that provides and/or operates some or all of the software that provides the service(s) 542; and/or 2) third-party datacenter(s), which are datacenter(s) owned and/or operated by one or more different entities than the entity that provides the service(s) 542 (e.g., the different entities may host some or all of the software provided and/or operated by the entity that provides the service(s) 542). For example, third-party datacenters may be owned and/or operated by entities providing public cloud services.

The system 540 is coupled to user devices 580A-580S over a network 582. The service(s) 542 may be on-demand services that are made available to one or more of the users 584A-584S working for one or more entities other than the entity which owns and/or operates the on-demand services (those users sometimes referred to as outside users) so that those entities need not be concerned with building and/or maintaining a system, but instead may make use of the service(s) 542 when needed (e.g., when needed by the users 584A-584S). The service(s) 542 may communicate with each other and/or with one or more of the user devices 580A-580S via one or more APIs (e.g., a REST API). In some implementations, the user devices 580A-580S are operated by users 584A-584S, and each may be operated as a client device and/or a server device. In some implementations, one or more of the user devices 580A-580S are separate ones of the electronic device 500 or include one or more features of the electronic device 500.

In some implementations, the system 540 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

In some implementations, the system 540 is any generic network interface management system that uses web interfaces and includes server application components, client application components and a browser extension. The system and method provide for authenticating the end user via a browser extension that needs to be available in the intended user's web browser. The input to the system and method is the information about the views and its specific fields or any other part that is rendered and need to be protected, as provided by the application owner. Typical generic examples are Java clients and applications, Python based frameworks, libraries for client applications implementing the logic described above.

In some implementations, the system 540 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to monitor and control information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 540 is a multi-tenant cloud computing architecture supporting multiple services, such as one or more of the following types of services: Customer relationship management (CRM); Configure, price, quote (CPQ); Business process modeling (BPM); Customer support; Marketing; Predictive Product Availability for Grocery Delivery; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“application store”); Data modeling; Security; and Identity and access management (IAM). For example, system 540 may include an application platform 544 that enables PAAS for creating, managing, and executing one or more applications developed by the provider of the application platform 544, users accessing the system 540 via one or more of user devices 580A-580S, or third-party application developers accessing the system 540 via one or more of user devices 580A-580S.

In some implementations, one or more of the service(s) 542 may use one or more multi-tenant databases 546, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user devices 580A-580S communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the multi-tenant database(s) 546 and/or system data storage 550.

In some implementations, the service(s) 542 are implemented using virtual applications dynamically created at run time responsive to queries from the user devices 580A-580S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 560 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which monitors and controls retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 540 and the user devices 580A-580S.

Each user device 580A-580S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 540. For example, the user interface device can be used to access data and applications hosted by system 540, and to perform searches on stored data, and otherwise allow one or more of users 584A-584S to interact with various GUI pages that may be presented to the one or more of users 584A-584S. User devices 580A-580S might communicate with system 540 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 580A-580S might include an HTTP client, commonly referred to as a “browser,” for sending and receiving HTTP messages to and from server(s) of system 540, thus allowing users 584A-584S of the user devices 580A-580S to access, process and view information, pages and applications available to it from system 540 over network 582.

In the above description, numerous specific details such as resource partitioning/sharing/duplication implementations, types and interrelationships of system components, and logic partitioning/integration choices are set forth in order to provide a more thorough understanding. Embodiments disclosed herein may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is illustrative and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method for deploying a trust layer for a generative AI application, the method comprising:
receiving a prompt from a user, by a large language model (LLM) gateway, via a user interface coupled with the LLM gateway;
receiving, by the LLM gateway, a plurality of configuration parameters controlling at least one of: data privacy, trust based content moderation, regulatory compliance, and a business context specific to the user, in the prompt, the configuration parameters being transparent to the user;
determining, by the LLM gateway, a presence of sensitive information in the prompt;
in response to determining that sensitive information is present in the prompt, receiving, by the LLM gateway, a moderated version of the prompt comprising a moderated version of the sensitive information;
receiving, by the LLM gateway, a response to the moderated version of the prompt;
determining, by the LLM gateway, a presence of unsafe information in the response;
in response to determining that unsafe information is present in the response, generating, by the LLM gateway, a safe version of the response comprising a moderated version of the unsafe information, in real-time, by controlling at least one of the configuration parameters; and
sending, by the LLM gateway, the safe version of the response to the user.

2. The method of claim 1, wherein the determining, by the LLM gateway, a presence of sensitive information in the prompt comprises determining at least one element of personally identifiable information (PII) in the prompt.

3. The method of claim 2, wherein the at least one element of personally identifiable information comprises personal identity, phone number, email address, location, social security number, income tax identification number, driving license number, passport number, credit card number, and bank account number.

4. The method of claim 3, wherein the determining, by the LLM gateway, a presence of unsafe information in the response comprises determining a toxic content in the prompt.

5. The method of claim 4, wherein the trust layer comprises a trust layer configurable by the user at a plurality of granularity levels comprising: an organization level, an application level, a prompt level, and a model level.

6. The method of claim 1, wherein the receiving, by the LLM gateway, a plurality of configuration parameters comprises:
querying an AI metadata service (AMS), by the LLM gateway, via a plurality of application programming interfaces (API), and
receiving from the AMS, by the LLM gateway, metadata associated with the LLM gateway, the metadata comprising information about the configuration parameters.

7. The method of claim 1, wherein the determining, by the LLM gateway, a presence of sensitive information in the prompt comprises: sending the prompt, by the LLM gateway, to a content moderation service (CMS) and determining, by the CMS, the presence of sensitive information in the prompt, and
further wherein receiving, by the LLM gateway, a moderated version of the prompt comprises: applying, by the CMS, a predetermined content quality moderating action on the prompt in real-time based on the configuration parameters, and generating the moderated version of the sensitive information.

8. A non-transitory machine-readable storage medium that provides instructions that, if executed by a processor, are configurable to cause said processor to perform operations comprising:
receiving a prompt from a user, by a large language model (LLM) gateway, via a user interface coupled with the LLM gateway;
receiving, by the LLM gateway, a plurality of configuration parameters controlling at least one of: data privacy, trust based content moderation, regulatory compliance, and a business context specific to the user, in the prompt, the configuration parameters being transparent to the user;
determining, by the LLM gateway, a presence of sensitive information in the prompt;
in response to determining that sensitive information is present in the prompt, receiving, by the LLM gateway, a moderated version of the prompt comprising a moderated version of the sensitive information;
receiving, by the LLM gateway, a response to the moderated version of the prompt;
determining, by the LLM gateway, a presence of unsafe information in the response;
in response to determining that unsafe information is present in the response, generating, by the LLM gateway, a safe version of the response comprising a moderated version of the unsafe information, in real-time, by controlling at least one of the configuration parameters; and
sending, by the LLM gateway, the safe version of the response to the user.

9. The non-transitory machine-readable storage medium of claim 8, wherein the determining, by the LLM gateway, a presence of sensitive information in the prompt comprises determining at least one element of personally identifiable information (PII) in the prompt.

10. The non-transitory machine-readable storage medium of claim 9, wherein the at least one element of personally identifiable information comprises personal identity, phone number, email address, location, social security number, income tax identification number, driving license number, passport number, credit card number, and bank account number.

11. The non-transitory machine-readable storage medium of claim 10, wherein the determining, by the LLM gateway, a presence of unsafe information in the response comprises determining a toxic content in the prompt.

12. The non-transitory machine-readable storage medium of claim 11, wherein the trust layer comprises a trust layer configurable by the user at a plurality of granularity levels comprising: an organization level, an application level, a prompt level, and a model level.

13. The non-transitory machine-readable storage medium of claim 8, wherein the receiving, by the LLM gateway, a plurality of configuration parameters comprises:
querying an AI metadata service (AMS), by the LLM gateway, via a plurality of application programming interfaces (API), and
receiving from the AMS, by the LLM gateway, metadata associated with the LLM gateway, the metadata comprising information about the configuration parameters.

14. The non-transitory machine-readable storage medium of claim 8, wherein the determining, by the LLM gateway, a presence of sensitive information in the prompt comprises: sending the prompt, by the LLM gateway, to a content moderation service (CMS) and determining, by the CMS, the presence of sensitive information in the prompt, and
further wherein receiving, by the LLM gateway, a moderated version of the prompt comprises: applying, by the CMS, a predetermined content quality moderating action on the prompt in real-time based on the configuration parameters, and generating the moderated version of the sensitive information.

15. A system comprising:
a processor;
a cloud-based computing resource digitally connected with the processor;
a non-transitory machine-readable storage medium that provides instructions that, if executed by the processor, are configurable to cause the system to perform operations comprising:
receiving a prompt from a user, by a large language model (LLM) gateway, via a user interface coupled with the LLM gateway;
receiving, by the LLM gateway, a plurality of configuration parameters controlling at least one of: data privacy, trust based content moderation, regulatory compliance, and a business context specific to the user, in the prompt, the configuration parameters being transparent to the user;
determining, by the LLM gateway, a presence of sensitive information in the prompt;
in response to determining that sensitive information is present in the prompt, receiving, by the LLM gateway, a moderated version of the prompt comprising a moderated version of the sensitive information;
receiving, by the LLM gateway, a response to the moderated version of the prompt;
determining, by the LLM gateway, a presence of unsafe information in the response;
in response to determining that unsafe information is present in the response, generating, by the LLM gateway, a safe version of the response comprising a moderated version of the unsafe information, in real-time, by controlling at least one of the configuration parameters; and
sending, by the LLM gateway, the safe version of the response to the user.

16. The system of claim 15, wherein the determining, by the LLM gateway, a presence of sensitive information in the prompt comprises determining at least one element of personally identifiable information (PII) in the prompt.

17. The system of claim 16, wherein the at least one element of personally identifiable information comprises personal identity, phone number, email address, location, social security number, income tax identification number, driving license number, passport number, credit card number, and bank account number.

18. The system of claim 17, wherein the determining, by the LLM gateway, a presence of unsafe information in the response comprises determining a toxic content in the prompt.

19. The system of claim 18, wherein the trust layer comprises a trust layer configurable by the user at a plurality of granularity levels comprising: an organization level, an application level, a prompt level, and a model level.

20. The system of claim 15, wherein the receiving, by the LLM gateway, a plurality of configuration parameters comprises:
querying an AI metadata service (AMS), by the LLM gateway, via a plurality of application programming interfaces (API), and
receiving from the AMS, by the LLM gateway, metadata associated with the LLM gateway, the metadata comprising information about the configuration parameters.

21. The system of claim 15, wherein the determining, by the LLM gateway, a presence of sensitive information in the prompt comprises: sending the prompt, by the LLM gateway, to a content moderation service (CMS) and determining, by the CMS, the presence of sensitive information in the prompt, and
further wherein receiving, by the LLM gateway, a moderated version of the prompt comprises: applying, by the CMS, a predetermined content quality moderating action on the prompt in real-time based on the configuration parameters, and generating the moderated version of the sensitive information.
